(19) United States
(12) Patent Application Publication
(10) Pub. No.: US 2005/0221770 A1
(43) Pub. Date: Oct. 6, 2005

(54) User configurable pre-activated GPRS PDP context handling for improved activation time

(76) Inventor: Michael D. Shipshock, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 10/814,366

(22) Filed: Mar. 31, 2004

(51) Int. Cl. H04B 7/00

(52) U.S. Cl. 455/88; 455/72

(57) ABSTRACT

A mobile station (103) which comprises a menu (105) for selecting pre-configured packet data protocol (PDP) context settings. The selected setting is established on a GPRS network (101) in advance of connection of a terminal equipment (TE) (107). The mobile station (103) receives a DNS IP address and an assigned IP address and maintains the PDP context in an active state, waiting for connection of a terminal equipment (TE) (107). The TE (107) may connect to the mobile station (103) via a variety of transports. During establishment of a PPP link (211) between the mobile station (103) and TE (107), the previously obtained DNS IP and assigned IP addresses are used thereby saving connection time. There is also a mobile station (103) which comprises a default PDP context setting that is activated upon power up of the mobile station (103). A TE (107) will use the default setting if appropriate, or otherwise will establish a new PDP context.

### FIELD OF THE INVENTION

The present invention relates generally to cellular networks, and more particularly to GPRS PDP context activation over a wireless network for PDA, PCs and similar terminal equipment using a mobile station for establishing network connectivity.

### BACKGROUND OF THE INVENTION

Communication networks such as GSM, WCDMA, EDGE and particularly those networks employing General Packet Radio Service (GPRS) enable Packet Data Protocol (PDP) communication via PDP context activation for wireless handheld devices such as mobile stations, Personal Digital Assistants (PDAs), and personal computers (PCs) using “always-connected” technology.

However, external PDP contexts often are not reliably established for devices on GPRS networks due to a variety of reasons such as Point-to-Point Protocol (PPP) timeout, limited support on PDA devices for configuration of “access point name” (APN) and quality of service (QoS) parameters required for PDP context activation.

In a GPRS network, to establish a PDP context activation, the terminal equipment (TE) must perform LCP, authentication, and begin IPC between the TE and the handheld device prior to transmission of a PDP context activation request to for example, a GSM/UMTS network. The network can take as long as thirty seconds to respond to the request. Further, in cases of transmission error there are typically three re-tries, thirty seconds apart. Therefore, a successful PDP context activation confirmation from the network may take as long as 120 seconds.

The PDP context activation process may take longer than PPP timeout settings of a TE device, which may be for example 10 or 20 seconds. Although PCs may have configurable PPP timeout settings, most smaller TE devices do not allow configuration of PPP timeout settings. Therefore, a requested PDP context may not activate prior to a TE's specific PPP timeout. Another problem is that the user may simply become impatient waiting for activation and manually terminate and re-try prior to successful PDP context activation.

External TE devices utilize a software tool for PDP context activation. The software tool is provided by the mobile manufacturer or the service provider. However, such software is usually only available on PC operating systems and is often not available for PDA or other non-PC devices. Therefore, establishing GPRS connectivity is difficult for such non-PC devices. Further problematic is that such devices have limitations on the number of characters that can be entered in custom scripts which are created for configuring GPRS PDP contexts.

A successful PDP context activation, assuming the PC will not time out in any manner, will typically take between 3 and 10 seconds. This time period is perceivable as slow by users and therefore creates a marketing problem for “always-connected” advertising campaigns.

Therefore, a need exists for a method and apparatus for increasing reliable PDP context activation on GPRS networks and avoiding various problems such as the one caused by PPP timeout.

### BRIEF DESCRIPTION OF THE DRAWINGS

FIG. 1 is a block diagram illustrating a network in which a mobile station may establish a PDP context.

FIG. 2 is a message flow diagram illustrating the basic messaging logic that occurs between a network, mobile station, and external device for connecting the external device to a mobile station having a pre-configured PDP context over a GPRS link, in accordance with the present invention.

FIG. 3 is a block diagram illustrating user selection and pre-activation of a pre-configured PDP context via a mobile device menu in accordance with some embodiments of the present invention.

FIG. 4 is a block diagram illustrating user pre-configuration of PDP contexts in accordance with some embodiments of the present invention.

FIG. 5 is a flow diagram illustrating pre-activation of a PDP context in accordance with some embodiments of the present invention.

FIG. 6 is a flow diagram illustrating a method of using a pre-configured, pre-activated PDP context by a device attaching to a mobile station, in accordance with some embodiments of the present invention.

### DETAILED DESCRIPTION OF THE PREFERRED EMBODIMENTS

To address the above-mentioned need, an apparatus and method for enabling user configurable pre-activated GPRS PDP context handling is provided herein.

In accordance with the present invention, a mobile station comprises user menus for configuring one or more PDP contexts, such that connectivity between external TE devices may be established in a rapid manner. The PDP context between the mobile station and the external TE device may be over any of a variety of transport mechanisms including, but not limited to, USB, RS232, IrDa, Bluetooth, 802.11, etc.

In particular for some embodiments of the present invention, the mobile station menus enable configuration of access point name (APN), PDP type, PDP address, quality of service (QoS) parameters and compression type. It is to be understood that other configuration parameters may be configurable and/or selectable by the menus and still remain in accordance with the present invention. Default settings, such as customer specific and operator specific, may be included in the mobile station during manufacturing of the mobile station.

There are two methods of PDP context pre-activation in accordance with embodiments of the present invention. In a first method, a mobile station may comprise a default setup for external PDP contexts in which the default PDP context is active at all times. The PDP context would, in this case, be activated upon power up of the mobile station and remain in an active state as long as the mobile station is powered on. The default settings may be set by the manufacturer, user selectable via a pre-configured PDP context menu, or a combination of manufacturer defaults with user options. Additionally, the default settings may be added or modified via over-the-air or other suitable provisioning methods subsequent to device manufacturing.

The network provides the mobile station with a DNS IP address and an assigned IP address in a PDP context activation confirmation message. If the user attempts to use GPRS services via an external TE device, the given DNS IP address and assigned IP address will be used.

Because of the known IP addresses, IPCP messaging between the mobile station and the external TE can be completed very quickly. In this case, the user will perceive almost instant GPRS connectivity after attaching an external TE to the mobile station. Further, the attached TE device can be any device supporting a PPP type dial-up connection and need not comprise GPRS software in order to function.

In a second method of PDP context activation, in accordance with embodiments of the present invention, the user may select via a menu, one of several pre-configured PDP context settings and thereafter select to immediately activate the PDP context. A PDP context is then established between the mobile station and the network wherein the network assigns a DNS IP address and an IP address. The PDP context will then be in a ready state for providing connectivity to an external TE device.

For example, the user may then attach the TE device to the mobile station and have almost instant GPRS connectivity. As in the first method of the present invention, IPCP messaging between the mobile station and TE device will occur rapidly due to the known DNS IP and assigned IP. Also as in the first method of the present invention, the TE device can be any device that supports a PPP type dial-up connection and need not have GPRS software for operation.

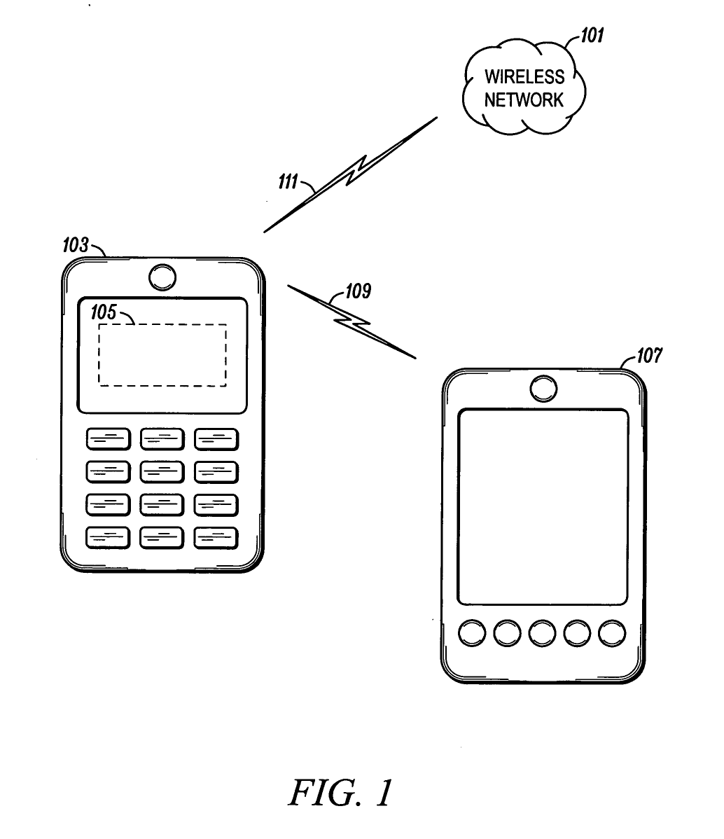

Turning now to the drawing wherein like numerals represent like components, FIG. 1 is a block diagram illustrating basic operation of a mobile station and an external device making use of a PDP context. Mobile station 103 communicates with a wireless network 101, which may be a GSM, UMTS, EDGE, etc. network employing GPRS. The communication between mobile station 103 and wireless network 101 is accomplished via a radio communications link 111. Mobile station 103 comprises a display suitable for presenting one or more menus 105 to the mobile station 103 user.

An external TE 107, which may be a PDA, PC, or any similar device is capable of communicating with mobile station 103 via link 109. Link 109 may be a wireless link as shown and may be a Bluetooth, IrDA, 802.xx, or other wireless link. However, link 109 may also be accomplished by means of a physical cable connection between mobile station 103 and TE 107, and may use transports such as, but not limited to USB, RS232, IEEE fire wire, etc.

The basic operation of systems such as the one illustrated by FIG. 1 involves connection of TE 107 to mobile station 103 via link 109, and subsequent establishment of a PDP context between mobile station 103 and network 101 as known by those of ordinary skill in the art.

In embodiments of the present invention however, a user pre-activates a PDP context for subsequent connection to a TE device. Therefore, in the embodiments of the present invention, a user who connects TE 107 to the mobile station 103 will perceive a much quicker connection time than that which may occur using prior art systems.

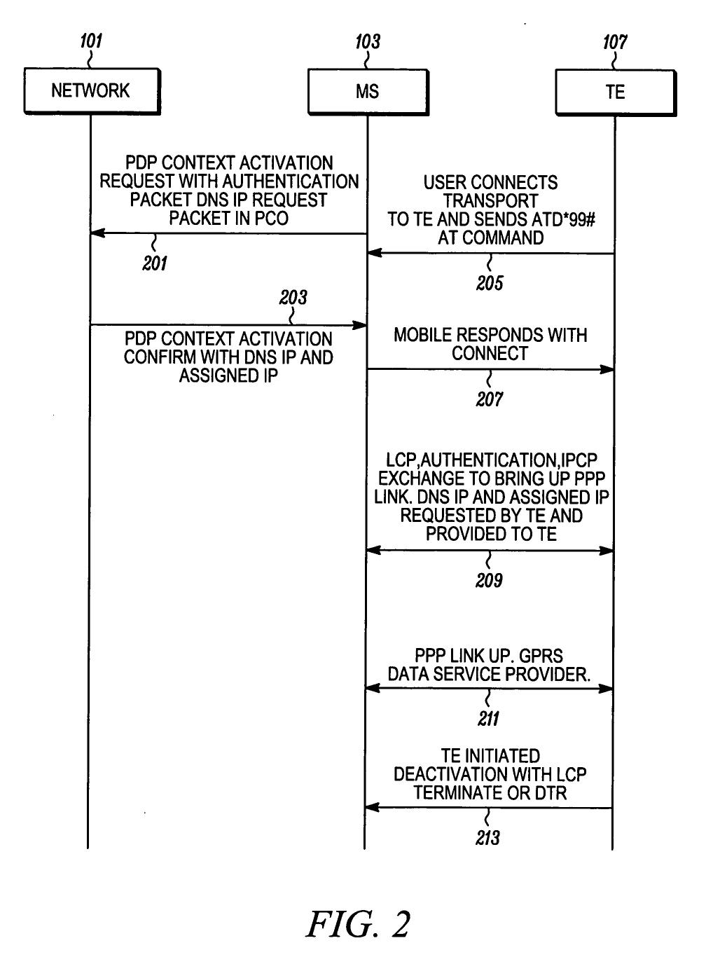

FIG. 2 is a message flow diagram in accordance with the present invention and illustrates the logic operation for connecting a TE device via a pre-configured PDP context over a GPRS link. Initially, MS 103 will transmit a PDP context activation request to network 101 via message 201. The request message 201 comprises a DNS IP request packet. The network 101 confirms that the PDP context activation has occurred via message 203. Message 203 comprises a DNS IP and an assigned IP for the PDP context which is stored by mobile station 103. The mobile station 103 is then ready to be connected to an external TE, such as TE 107.

The TE 107 connection 109 to mobile station 103, may be established via a variety of transports such as, but not limited to, Bluetooth, IrDA, 802.xx, USB, RS232, IEEE fire wire, etc. In some embodiments of the present invention, the TE 107 sends an “AT” command message 205 similar to establishing a modem connection. The mobile station 103 responds with “CONNECT” message 207. It is to be understood that, in the various embodiments of the present invention, various mechanisms may be used to establish mobile station to TE connectivity in accordance with the particular transport employed, and still remain in accordance with the present invention. For example, an RS232 cable line has a “carrier detect line” which detects a connection and readiness for data transfer while USB simulates such a line. Therefore, while AT commands may be used as described herein, such commands are for exemplary purposes only and are not to be construed as a limitation on the various embodiments of the present invention.

Continuing now with the exemplary connection establishment illustrated in FIG. 2, the mobile station 103 and TE 107 proceed to establish PPP link 209 via LCP, TE authentication which may or may not be required, and IPCP. Important to note is that the DNS IP and assigned IP which were provided to mobile station 103 by network 101 are available for response to the TE 107 request. Therefore in communications link 209, when TE 107 requests a DNS IP and assigned IP address, the mobile station 103 provides the DNS IP and assigned IP that was previously provided by the network 101 via PDP context activation confirmation message 203.

After establishment of the PPP link 209, GPRS data service 211 is provided to the TE 107. The TE 107 may thereafter terminate the session via for example an LCP terminate or DTR message 213.

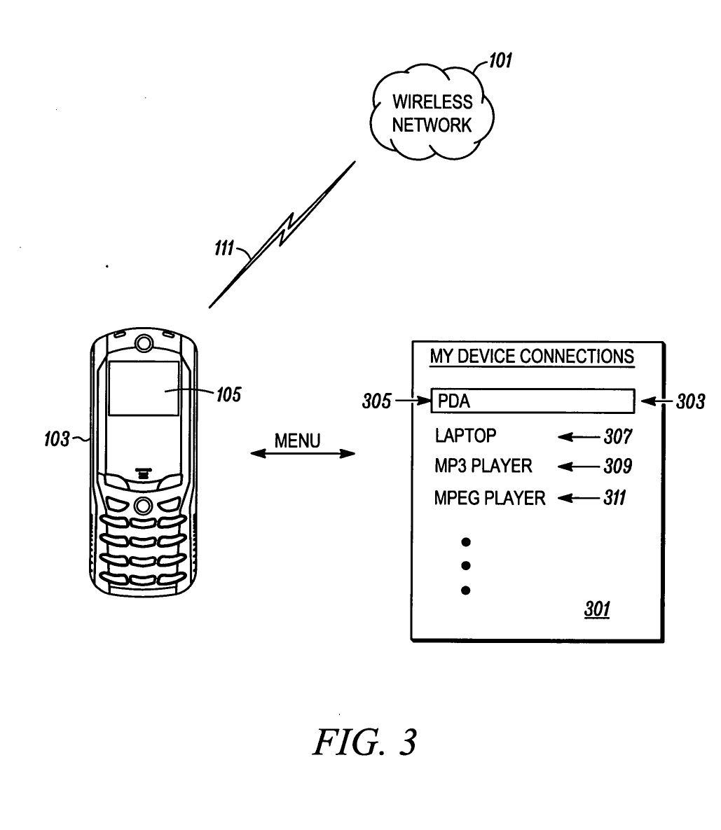

FIG. 3 illustrates menu selection and pre-activation of a pre-configured PDP context. In FIG. 3, menu 301 comprises a list of various selectable TE devices having pre-configured settings. For example, the user may position cursor 303 over PDA 305 as shown and select PDA 305 for pre-activation. Likewise, other devices such as but not limited; to Laptop 307, mp3 player 309 and mpeg player 311 may be selected as shown. After the user makes the desired selection, mobile station 103 will make the appropriate PDP context activation request to the network 101 and receive a DNS IP and assigned IP. The mobile station, and the PDP context, will then be in a ready state such that the selected TE may be connected to the mobile station and rapidly make use of the PDP context.

It is to be understood that the text menu illustrated by FIG. 3 is for exemplary purposes only and that other menu layouts, dress, and representations may be used, for example iconic representations, and still remain in accordance with the embodiments of the present invention.

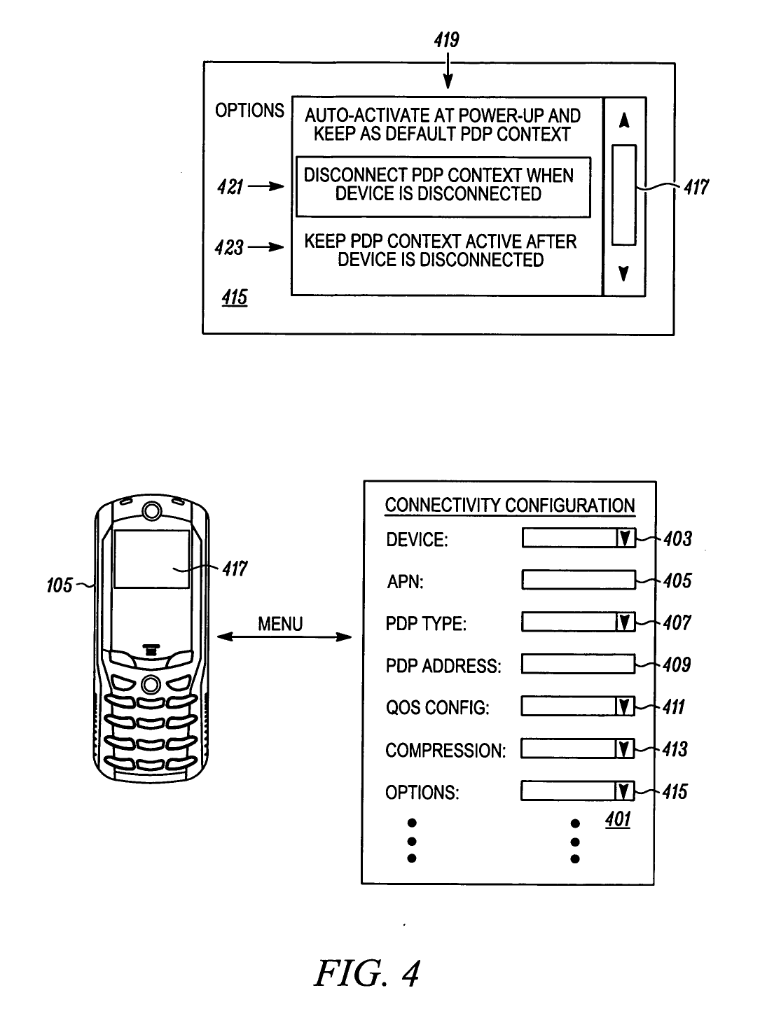

FIG. 4 illustrates further details of the PDP context configuration settings that the pre-configured settings may comprise in some embodiments of the present invention. Further illustrated by FIG. 4 is that the configuration settings may be modified by the user in some embodiments. Alternatively or additionally, the settings may be made or modified by over-the-air or other suitable provisioning methods of a network operator.

In FIG. 4, each device listed in menu 301, each of which is a TE device, will have a corresponding configuration table such as settings table 401. Further, in embodiments where such settings are user configurable, table 401 will be a menu 401 having entry places and/or selectable sub-menus for adding new parameters and modifying parameters. For example, menu 401 has entry places for APN 405 and PDP address 409. Menu 401 also has selectable sub-menus for device 403, PDP type 407, QoS Configuration 411, Compression 413 and Options 415.

Each sub-menu of menu 401 may have further sub-menus depending upon the required level of granularity. For example, option sub-menu 415 may have selectable items “auto-activate at power-up and keep as default PDP context” 419, “disconnect PDP context when device is disconnected” 421, and “keep PDP context active after device is disconnected” 423 selectable options. The options may be scrollable using a scrollbar 417, and selectable via a cursor.

In some embodiments of the present invention, menu 415 enables a user to maintain a pre-activated PDP context even after a TE device has been disconnected from the mobile station. Alternatively, the user may desire to have the pre-activated PDP context deactivated at the time the TE device is disconnected from the mobile station by selecting for example, menu item 421.

The user may also select a start-up PDP context activation as shown by menu item 419. Other configuration options may also exist and still remain in accordance with the embodiments of the present invention.

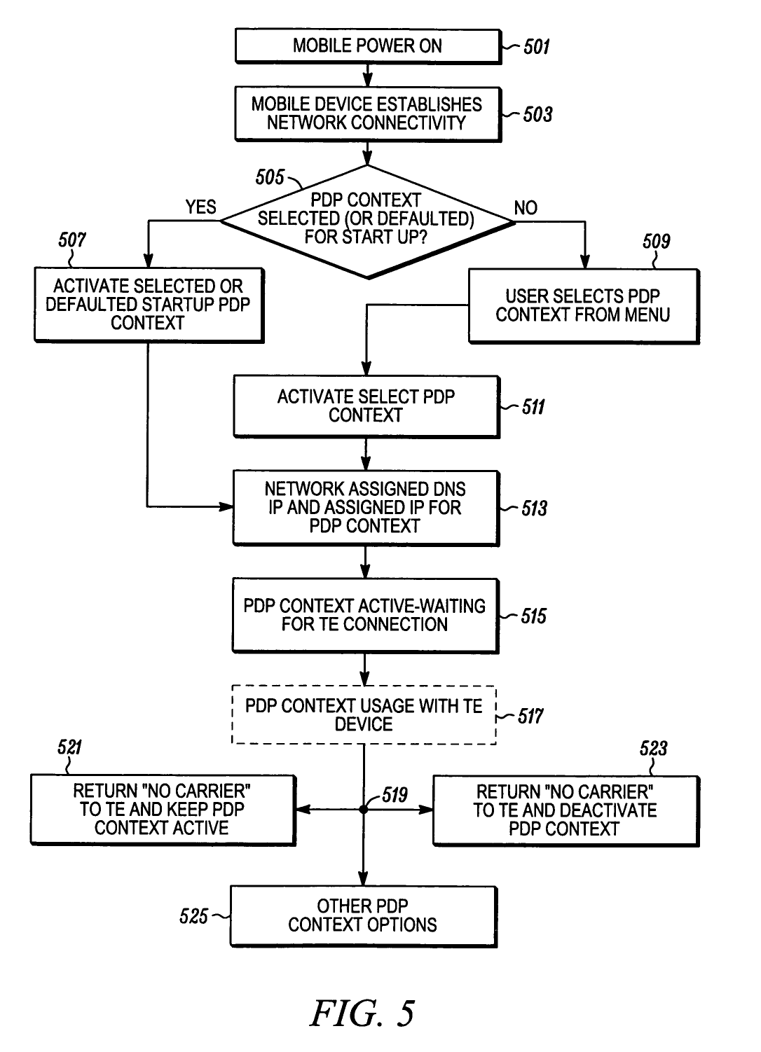

FIG. 5 is a flow diagram illustrating pre-activation of a PDP context by using, for example menu 301, or by setting a power-up default PDP context using menus 401 and 415. In 501, the user powers-on the mobile station. In 503, the mobile station establishes network connectivity in a normal manner in accordance with standard procedures. However, in block 505 in accordance with embodiments of the present invention, if a start-up PDP context has been defaulted or specified, the particular PDP context will be activated in block 507. In block 513 the mobile station maintains the network assigned DNS IP and IP for later PDP context connection to a TE. The mobile station and the PDP context remain in a ready state as shown in block 515, until a TE device is connected.

Returning to block 505, if no start-up PDP context is specified, the user may select a pre-configured PDP context to activate, via a mobile station menu such as menu 301, as shown in block 509. The mobile station will establish the selected PDP context activation as shown in block 511. In block 513 the mobile station maintains the network assigned DNS IP and IP for later PDP context connection to a TE, and remains in a ready state as shown in block 515, until a TE device is connected.

In block 517, a TE is connected, and makes use of the pre-activated PDP context. After the TE is disconnected from the mobile station, a variety of possible actions may be taken in accordance with a defaulted setting, pre-configured setting, or user selectable setting. For example, OR-function 519 may represent the options of a menu such as menu 415. In this case, block 521 would correspond to user selectable menu option 423, and the PDP context would remain active even after the TE is disconnected from the mobile station. Likewise, block 523 corresponds to menu option 421. Any other disconnect option may be implemented as shown by block 525.

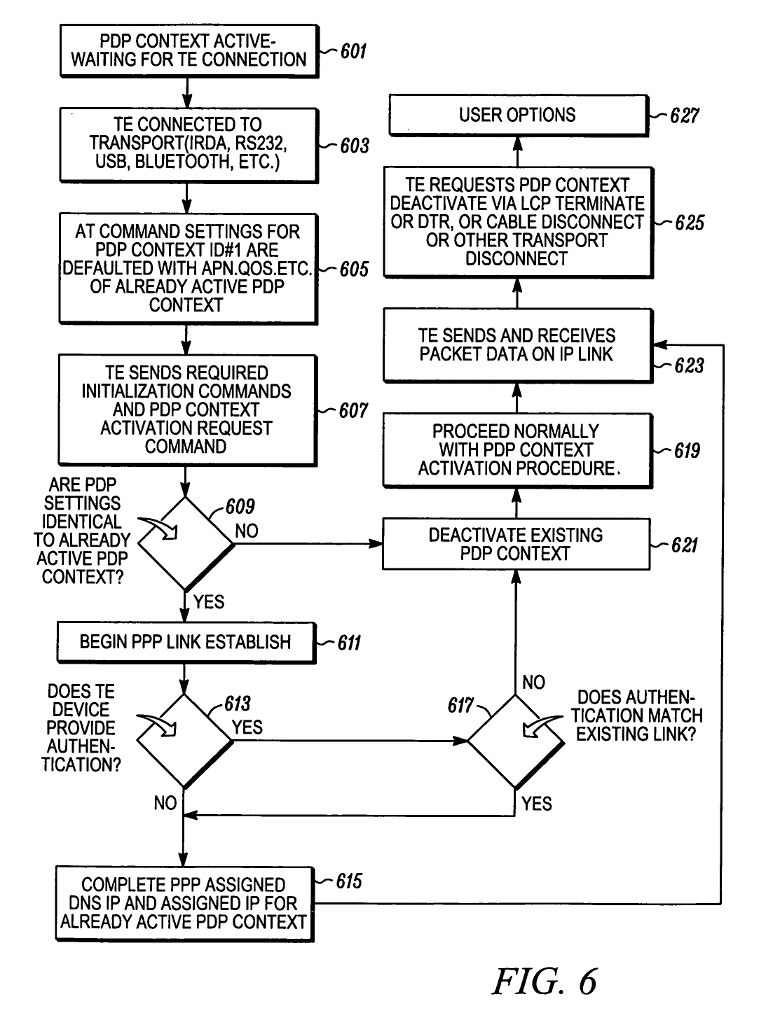

FIG. 6 illustrates basic operation of a method of using a pre-configured PDP context activation by a device attaching to a mobile station, in accordance with the embodiments of the present invention. Further, FIG. 6 corresponds to actions that occur in block 517 of FIG. 5. In 601, a mobile station has an established PDP context with a network, and is ready to be connected, and provide service to, a TE device. In 603, the TE is connected via one of a variety of transports such as IrDa, RS232, USB, Bluetooth, etc.

For pre-configured PDP context activation, in accordance with the present invention, one of two possible methods may be employed as discussed previously. Either a default setup for PDP context activation may be used in which the default PDP context is activated upon mobile station power up and remains active until needed by a TE; or the user may select a pre-configured PDP context via a mobile station menu and further select to activate that particular PDP context. The mobile station will then establish the selected PDP context with the network and maintain the PDP context activation until needed by a TE.

In block 605 a pre-configured PDP context setting for PDP context ID #1 has a default APN, QoS etc. and corresponding “AT” command settings in some embodiments. It is to be understood that a context ID need not be sent in some embodiments and that if no context ID is sent a default context will be used by the mobile station such as context ID #1 or other context Ids determined by the menu or pre-programmed defaults in accordance with the present invention. In 607, a TE device, which is connected to the mobile station, requests GPRS service via a PDP context activation request command. As illustrated in 609, if the requested PDP context is identical to the already active PDP context, the TE and mobile station will begin establishment of a PPP link 611. In some embodiments, the TE will comprise an authentication function as illustrated in 613. If this is the case, then the authentication must match the existing GPRS link as shown in 617. If the TE authentication matches, then the PPP link 615 is established between the mobile station and the TE using the assigned DNS IP and assigned IP addresses of the already active PDP context.

If no authentication of the TE is required as shown in 613, the mobile station and TE simply proceed to establish a PPP link 615. However, if authentication is required for the TE and the TE authentication does not match the existing GPRS link as in 617, then a new PDP context request will be sent by the mobile station to the network, and PDP context activation will occur as would be the case without the embodiments of the present invention 619. The procedure of block 619 may require a preceding deactivation of any existing active PDP context as shown in block 621. However this deactivation process will be controlled by the network and operate with the mobile station as a normal PDP context deactivation as would be the case without the embodiments of the present invention.

Likewise, if the PDP settings required by the TE do not match the already active PDP context as shown in 609, a new PDP context request will be sent by the mobile station to the network, and PDP context activation will occur in block 619 as would be the case without the embodiments of the present invention. Again, it is to be understood that a preceding PDP context deactivation may be required as shown in block 621.

Whether a PPP link is established using the DNS IP and assigned IP of the pre-configured PDP context as in 615, or a new PDP context is established as in 619, the TE may then make use of the IP link 623 to transmit and receive data. The TE may request PDP context deactivation in 325, in which case the mobile station will transmit, for example, a “no carrier” signal to the TE, thereby terminating the TE GPRS session. However, the PDP context may still remain active in accordance with user option setting as shown in block 627, and as previously described herein.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A mobile station comprising:
a first wireless transceiver for communicating with a wireless network;
a second transceiver for communicating with a remote device; and
a menu for selecting one of a plurality of packet data context settings and establishing a packet data context in accordance therewith.

2. The mobile station of claim 1, wherein said second transceiver is a wireless transceiver.

3. The mobile station of claim 1, wherein each of said plurality of packet data context settings comprises an access point name and a quality of service parameter.

4. A mobile station comprising:
a first wireless transceiver for communicating with a wireless network;
a second transceiver for communicating with a remote device; and
a default packet data context setting for establishing a packet data context in accordance with said setting upon power up of said mobile station.

5. The mobile station of claim 4, wherein said second transceiver is a wireless transceiver.

6. The mobile station of claim 4, wherein each of said plurality of packet data context settings comprises an access point name and a quality of service parameter.

7. A method of establishing packet data service for a remote device comprising:
transmitting by a mobile station a packet data context request to a network;
receiving from said network a packet data context activation confirmation and at least one internet protocol address;
receiving by said mobile station a connect request from a remote device;
establishing a communications link between said mobile station and said remote device; and
providing packet data service to said remote device using said at least one internet protocol address.

8. The method of claim 7, wherein said network is a GPRS network.

9. The method of claim 7, wherein said at least one internet protocol address is a DNS IP address.

10. The method of claim 7, wherein said connect request is an atd*99#AT command.

11. The method of claim 7, wherein said communications link is a Point-to-Point Protocol link.

12. The method of claim 7, wherein said remote device is one of a personal digital assistant, personal computer, music file player, and video player.

13. The method of claim 12, wherein said music file player is an MP3 player.

14. The method of claim 12, wherein said video player is an MPEG player.

15. A method of establishing packet data service for a remote device comprising:
receiving by a mobile station, a command to establish a packet data context corresponding to one of a plurality of selectable packet data context configurations;
transmitting by said mobile station a packet data context request to a network wherein said packet data context request corresponds to said command;
receiving from said network a packet data context activation confirmation and at least one internet protocol address;
receiving by said mobile station a connect request from said remote device;
establishing a communications link between said mobile station and said remote device; and
providing packet data service to said remote device using said at least one internet protocol address.

16. The method of claim 15, wherein said network is a GPRS network.

17. The method of claim 15, wherein said at least one internet protocol address is a DNS IP address.

18. The method of claim 15, wherein said connect request is an atd*99# AT command.

19. The method of claim 15, wherein said communications link is a Point-to-Point Protocol link.

20. The method of claim 15, wherein said remote device is one of a personal digital assistant, personal computer, music file player, and video player.

21. The method of claim 20, wherein said music file player is an MP3 player.

22. The method of claim 20, wherein said video player is an MPEG player.
